(19) United States
(12) Patent Application Publication
(10) Pub. No.: US 2026/0085656 A1
(43) Pub. Date: Mar. 26, 2026

(54) SYNTHETIC INERTIA CONTROL METHOD AND SYSTEM OF A WIND TURBINE GENERATOR

(71) Applicant: Korea Renewable Energy Institute Inc., Jeonju (KR)

(72) Inventor: Yong Cheol KANG, Jeonju (KR)

(21) Appl. No.: 18/892,813

(22) Filed: Sep. 23, 2024

(51) Int. Cl. F03D 7/02; F03D 7/04

(52) U.S. Cl. CPC F03D 7/028; F03D 7/043; F05B 2270/327; F05B 2270/337

(57) ABSTRACT

The present invention relates to a synthetic inertia control method that includes performing maximum power point tracking control, detecting a frequency deviation in a power system, and switching, when the frequency deviation is greater than a predetermined value, the maximum power point tracking control to temporary frequency support control, wherein the temporary frequency support control includes a first stage of calculating and controlling, for a predetermined first time period from a time point (conversion time point) at which the maximum power point tracking control is converted to the temporary frequency support control, an active power reference value that is increased from an original reference value according to the maximum power point tracking control at the conversion time point, and the increased active power reference value according to the temporary frequency support control is calculated as a function of the frequency deviation and a rotor speed of the wind turbine generator.

### BACKGROUND OF THE INVENTION

### Field of the Invention

The present disclosure relates to a synthetic inertia control method and system of a wind turbine generator, and more specifically, to a synthetic inertia control method and system of a wind turbine generator that temporarily releases, when a disturbance such as dropping out of a generator occurs in a power system to cause a system frequency to dip sharply, kinetic energy stored in a rotating body of the wind turbine generator so as to rise a lowest frequency to secure system stability.

### Background of the Related Art

When a disturbance such as dropping out of a generator occurs in a power system, kinetic energy stored in a rotating body of a synchronous generator is naturally released, thereby causing a system frequency to dip sharply. This phenomenon is referred to as an inertia response of a synchronous generator.

When a frequency decreases below 59.964 Hz, a governor of an online synchronous generator increases its output in proportion to a frequency deviation, which is referred to as primary frequency control. When an output of an online synchronous generator increases and an amount of increase in the output becomes equal to a capacity of the generator that has been tripped, a frequency reaches a lowest point. The frequency at this time is referred to as a lowest frequency (frequency nadir). After the frequency rebounds, the frequency converges to a certain value, which is referred to as a settling frequency.

When the frequency of the power system drips below 59.8 Hz, automatic generation control (AGC), which has been operated to maintain the frequency at a rated frequency during a normal operation, stops its operation. When the settling frequency converges over 59.8 Hz again after a disturbance occurs, the AGC is reactivated to recover the frequency to 60 Hz, and this control is referred to as secondary frequency control.

According to the power system reliability and power quality maintenance standard in the Republic of Korea, when one generator trips, the lowest frequency must be above 59.7 Hz, and the settling frequency must be above 59.8 Hz. In addition, when two generators trip, the lowest frequency must be above 59.2 Hz, and the settling frequency must rise above 59.5 Hz within 1 minute and above 59.8 Hz within 10 minutes.

In the existing system, which is configured with only a synchronous generator, the synchronous generator is an entity that performs frequency control when a disturbance occurs. That is, the synchronous generator retains primary and secondary reserve power specified in the reliability standard and releases the retained power when a disturbance occurs, thereby preventing the frequency from dipping and then recovering it to the rated frequency.

A wind turbine generator performs maximum power point tracking (MPPT) control to adjust a rotor speed to an optimal rotor speed according to a varying wind speed to produce maximum energy. To this end, a reference value of active power is set in proportion to a cube of a rotor speed. An MPPT operation denotes that the active power of the wind turbine generator is adjusted according to a rotor speed rather than a system frequency. When a number of wind turbine generators are connected to a system, a synchronous generator is separated to balance supply and demand. At this time, when only MPPT control of the wind turbine generator is performed, the inertia response and primary frequency control capability of the synchronous generator deteriorate when a disturbance occurs.

As a result, the lowest frequency decreases, the reliability standard cannot be satisfied, and in severe cases, this may lead to a power outage.

In order to solve the foregoing problems, a synthetic inertia technology has been proposed in which a wind turbine generator performs MPPT control during a normal operation and then temporarily releases kinetic energy stored in a rotating body after a disturbance. Wind turbine synthetic inertia technology is divided into a frequency-based synthetic inertia method and a stepped synthetic inertia method.

Non-Patent Document 0001 proposes a method of reducing active power with a predetermined slope to solve a problem of occurrence of a secondary frequency dip (SFD) phenomenon due to an instantaneous reduction in the active power to recover the rotor speed in the stepped synthetic inertia method.

FIG. 1 shows an active power reference value P_{ref} in Non-Patent Document 0001, wherein it can be observed that an active power decreases with a constant slope in a section B′-C. However, in order to recover the rotor speed, the active power at C must be smaller than a mechanical input to the wind turbine generator, but there is a problem in that C must be found by trial and error to determine this.

In addition, since this method increases the set large active power when a wind speed is high even though the wind speed is small, an over-deceleration (OD) phenomenon in which the rotor speed reaches the minimum rotor speed may occur during synthetic inertia control. When the OD phenomenon occurs, the rotor speed of the wind turbine generator decreases further, which may cause stalling, where the rotating body of the wind turbine generator stops its rotation. In order to prevent the stall, the active power of the wind turbine generator must be reduced rapidly to a point where it intersects an MPPT control curve, which requires a significant amount of output to be reduced rapidly, and during the process, a secondary frequency dip may occur, which may be lower than a primary lowest frequency.

Unlike Non-Patent Document 0001 in which an active power reference value of a wind turbine generator is set in a time domain, Non-Patent Document 0002 proposes a method of setting an active power reference value P_{ref} in an active power-rotor speed plane as shown in FIG. 2.

FIG. 2 shows a process of a section A-B′ in which an active power output is momentarily increased by a predetermined value and then maintained, a section B′-C in which a rotor speed is reduced and converged through a decrease in the active power, a section C-D in which the rotor speed is recovered to an MPPT control curve, and a section D-A in which the rotor speed is recovered to a rotor speed before a disturbance occurs along the MPPT control curve.

In FIG. 2, P_{TFS} is an active power reference value for synthetic inertia control when a disturbance occurs, P_{Tlim} is an active power value converted based on a torque limit of a rotating body, Pₘ is an external input obtained from a rotating body of a wind turbine generator, and P_{MPPT} is an active power value according to maximum power point tracking control in the wind turbine generator.

Non-Patent Document 002 has an advantage of effectively preventing OD by converging the rotor speed to a stable range. However, immediately after a disturbance occurs (AB, BB′), the active power is increased by a constant amount regardless of a magnitude of the disturbance and then output, and thus there is a problem in that when the magnitude of the disturbance is small, an amount of increase in the active power of the wind turbine generator is relatively too large to cause the frequency to exceed 60 Hz and then decrease again, thereby resulting in a frequency fluctuation phenomenon in which the frequency exceeds and decreases repeatedly. In addition, when a wind speed is low, an amount of increase in active power is small, which has a disadvantage of low lowest frequency improvement.

(Non-Patent Document 0001) S. E. Itani, U. D. Annakkage, and G. Joos, “Short-term Frequency Support Utilizing Inertial Response of DFIG Wind Turbines”, IEEE Power and Energy Society General Meeting, vol. 23, no. 2, 2011

(Non-Patent Document 0002) D. Yang, J. Kim, Y. C. Kang, E. Muljadi, N. Zhang, J. Hong, S.-H. Song, and T. Zheng, “Temporary Frequency support of a DFIG for high wind power penetration,” IEEE Trans. Power Syst., vol. 33, no. 3, pp. 3428-3437, May 2018.

### SUMMARY OF THE INVENTION

A technical problem to be solved by the present disclosure is to provide a synthetic inertia control method and system of a wind turbine generator that can rise a lowest frequency by differently regulating active power according to a magnitude of disturbance.

Another technical problem to be solved by the present disclosure is to provide a synthetic inertia control method and system of a wind turbine generator that can prevent a secondary frequency dip from occurring during a rotor speed recovery process after an increase in active power output.

Still another technical problem to be solved by the present disclosure is to provide a synthetic inertia control method and system of a wind turbine generator that can enhance system stability at low cost without additional cost for rising the lowest frequency using only kinetic energy stored in a rotating body of the wind turbine generator without using a separate energy storage device.

In order to solve the foregoing technical problems, a synthetic inertia control method by a control system of a wind turbine generator may include performing maximum power point tracking (MPPT) control, detecting a frequency deviation in a power system, and switching, when the frequency deviation is greater than a predetermined value, the maximum power point tracking (MPPT) control to temporary frequency support (TFS) control, wherein the temporary frequency support (TFS) control includes a first stage of calculating and controlling, for a predetermined first time period from a time point (conversion time point) at which the maximum power point tracking (MPPT) control is converted to the temporary frequency support (TFS) control, an active power reference value that is increased from an original reference value according to the maximum power point tracking (MPPT) control at the conversion time point, and the increased active power reference value according to the temporary frequency support (TFS) control is calculated as a function of the frequency deviation and a rotor speed of the wind turbine generator.

In order to solve the foregoing problems, a synthetic inertial control system of a wind turbine generator may include a frequency deviation detection unit that detects a frequency deviation of a power system from a reference frequency and a measured system frequency, a rotor speed detection unit that detects a rotor speed of a wind turbine generator, a switching unit that switches between maximum power point tracking (MPPT) control and temporary frequency support (TFS) control, an active power reference value calculation unit that calculates an active power reference value for wind turbine generator output control using the frequency deviation and the rotor speed and a control unit that controls a wind turbine generator according to the calculated active power reference value, wherein when switched to the temporary frequency support (TFS) control by the switching unit, the active power reference value calculation unit calculates an active power reference value that is increased from an original reference value according to the maximum power point tracking (MPPT) control at a time point (conversion time point) converted to the temporary frequency support (TFS) control, the increased active power reference value is calculated as a function of the frequency deviation and the rotor speed, and the control unit performs a first stage control according to an active power reference value calculated as a function of the frequency deviation and the rotor speed for a predetermined first time period from the conversion time point.

The frequency deviation and the rotor speed may be detected at predetermined time intervals, and the increased active power reference value of the first stage may be repeatedly calculated by the detected frequency deviation and rotor speed each time.

In one or more embodiments, the first time period may be a time period during which the system frequency deviation falls within a predetermined reference value after the system frequency has rebounded beyond the lowest frequency.

In one or more embodiments, the method may further include a second stage of continuously reducing the active power reference value to converge a speed of the rotor, and the active power reference value in the second stage may be calculated as a function of the rotor speed.

In one or more embodiments, the method may further include a third stage of reducing the active power reference value for a second time period to allow the speed of the rotor to reach a rotor speed on the maximum power point tracking (MPPT) control curve, and the active power reference value in the third stage may be calculated as a function of the rotor speed and a time.

In one or more embodiments, the method may further include a stage of terminating the temporary frequency support (TFS) control and switching back to the MPPT control when the speed of the rotor reaches a rotor speed on the MPPT control curve.

In one or more embodiments, an equation for calculating the active power reference value of the first stage may include a value obtained by multiplying the frequency deviation by a control gain that varies according to the speed of the rotor.

In one or more embodiments, the active power reference value of the first stage may be calculated by the following equation:

$${P}_{ref} ( {ω}_{r} , Δ f ) = k * F ( {ω}_{r} ) + a ( {ω}_{r} ) * Δ f , for {t}_{0} < t \leq {t}_{0} + {T}_{set}$$

Here, k may be an arbitrary constant, ωᵣ may be a speed of a rotor, F(ωᵣ) may be a function of or that varies with a rotor speed, α(ωᵣ) may be a control gain that varies with the rotor speed, Δf may be a deviation of a reference frequency and a measured system frequency, and Tₛₑₜ may be the first time period.

In one or more embodiments, the k*F(ωᵣ)=k_{g}ωᵣ³ (k_{g} is a constant for an MPPT operation).

In one or more embodiments, F(ωᵣ)=ωᵣⁿ (n is 0 or a natural number).

In one or more embodiments, the control gain α(ωᵣ) that varies with the rotor speed may be expressed by the following equation:

$$a ( {ω}_{r} ) = \sqrt{\frac{{G}_{max}^{2}}{{ω}_{max} - {ω}_{min}} ( {ω}_{r} - {ω}_{min} )}$$

Here, ωₘₐₓ may be a maximum rotor speed of the wind turbine generator, ωₘᵢₙ may be a minimum rotor speed, and Gₘₐₓ may be a control gain of ωₘₐₓ.

In one or more embodiments, in the second stage, the reference value of the active power may be reduced along a line connecting one of points under a Pm curve as well as within a region where ωᵣ<ω_{Tset} from a point in the first time period in an active power-rotor speed plane.

In one or more embodiments, the active power reference value of the second stage may be calculated by the following equation:

$${P}_{ref} ( {ω}_{r} ) = \frac{{P}_{ref} ( {T}_{set} )}{{ω}_{Tset} - {ω}_{min}} ( {ω}_{r} - {ω}_{min} )$$

Here, P_{ref} (Tₛₑₜ) and ω_{Tset} may be an active power reference value and a rotor speed, respectively, at a time point after the first time period has passed, ωᵣ may be a speed of a rotor, and ωₘᵢₙ may be a minimum rotor speed.

In one or more embodiments, the active power reference value of the third stage may be calculated by the following equation:

$${P}_{ref} ( {ω}_{r} , t ) = {k}_{g} {ω}_{r}^{3} + Δ {P}_{C} [ - \frac{1}{Δ T} ( t - {t}_{C} ) + 1 ] , for {t}_{C} < t \leq {t}_{C} + Δ T$$

Here, or may be a speed of a rotor, k_{g} may be a constant for an MPPT operation, ΔP_{c} may be a difference between active power and k_{g}ω_{c}³ at a rotor speed point (point C in FIG. 5) converged in the second stage, t_{c} may be a time point at point C, and ΔT may be a second time period set to reach a rotor speed on the MPPT control curve at point C.

In one or more embodiments, the ΔT may be above 45 seconds.

In one or more embodiments, the active power reference value calculation unit may calculate an active power reference value of the second stage that continuously decreases as a function of the rotor speed, and the control unit may perform a second stage control that continuously reduces active power according to the active power reference value of the second stage to converge a speed of the rotor.

In one or more embodiments, the active power reference value calculation unit may calculate an active power reference value of the third stage as a function of the rotor speed and a time, and the control unit may perform the third stage control for a second time period to allow the speed of the rotor to reach a rotor speed on the MPPT control curve according to the active power reference value of the third stage.

In one or more embodiments, the switching unit may terminate the temporary frequency support (TFS) control and switch back to the MPPT control when the speed of the rotor reaches a rotor speed on the MPPT control curve.

Specific details of other embodiments are included in the detailed description and drawings.

According to a synthetic inertia control method and system of a wind turbine generator in accordance with embodiments of the present disclosure, the following effects are obtained.

First, after a disturbance, an output is increased by multiplying a control gain, which is proportional to a frequency deviation and varies with a rotor speed, so when a rotor speed is high, an amount of increase in the output is large, thereby having a significant effect of rising a lowest frequency.

Second, even when a rotor speed is low, an output is increased according to a magnitude of a disturbance while preventing OD, thereby having a significant effect of rising a lowest frequency.

Third, a control gain is also reduced according to a rotor speed that decreases due to synthetic inertia control, thereby having a significant effect of reducing an amount of increase in the active power output.

Fourth, as a rotor speed decreases during synthetic inertia control, an MPPT reference value (k_{g}ωᵣ³) is also reduced, thereby improving an OD prevention effect.

Fifth, a lower frequency dip occurs during a rotor speed recovery process compared to a conventional method.

The effects of the present disclosure are not limited to the above-mentioned effects, and other effects that are not mentioned herein will be clearly understood by those skilled in the art from the description of the claims.

### BRIEF DESCRIPTION OF THE DRAWINGS

FIG. 1 is a diagram for explaining a related art of the present disclosure.

FIG. 2 is a diagram for explaining another related art of the present disclosure.

FIG. 3 is a block diagram for explaining a synthetic inertial control system of a wind turbine generator according to one embodiment of the present disclosure.

FIG. 4 is a flowchart for explaining a synthetic inertia control method of a wind turbine generator according to one embodiment of the present disclosure.

FIG. 5 is a graph showing a synthetic inertia control method of a wind turbine generator according to one embodiment of the present disclosure in an active power-rotor speed plane.

FIG. 6 is a graph showing a relationship between a control gain α(ωᵣ) with respect a rotor speed ωᵣ in Equation 2.

FIG. 7 shows a test system used to verify the performance of a synthetic inertia control method and system of a wind turbine generator according to embodiments of the present disclosure.

FIGS. 8A to 8C are graphs for explaining a result related to Verification Test Example 1 of the present disclosure.

FIGS. 9A to 9C are graphs for explaining a result related to Verification Test Example 2 of the present disclosure.

FIGS. 10A to 10C are graphs for explaining a result related to Verification Test Example 3 of the present disclosure.

### DETAILED DESCRIPTION OF THE PREFERRED EMBODIMENT

The advantages and features of the present invention and the method for achieving them will become clear by referring to the embodiments described below in detail together with the accompanying drawings. However, the present invention is not limited to the embodiments disclosed below and will be implemented in various different forms. These embodiments are provided only to make the disclosure of the present invention complete and to fully inform those skilled in the art of the scope of the present invention, and the present invention is only defined by the scope of the claims. Like reference numerals refer to like elements throughout the specification.

“And/or” includes each of the mentioned items and all combinations of one or more of the mentioned items.

The terms used in this specification are to describe the embodiments and are not to limit the present invention. In this specification, singular forms also include plural forms unless specially stated otherwise in the phrases. The terms “comprises” and/or “comprising” used in this specification means that the mentioned components, steps, operations, and/or elements do not exclude the presence or addition of one or more other components, steps, operations and/or elements.

In addition, throughout the specification, when a part is said to be “connected” to another part, this also includes “indirectly” or “electrically connected” cases with intervention of other members or components therebetween, as well as “directly connected” cases.

In addition, throughout the specification, the description that each layer (film), region, pattern, or structure is formed “above/on” or “beneath/under” a substrate, each layer (film), region, pad, or pattern includes both cases that they are formed directly and formed with intervention of other layers. The criteria for being above/on or beneath/under each layer are explained with reference to the drawings.

In addition, expressions such as ‘first, second’, and the like are only used to distinguish a plurality of components, and do not limit the sequence of the components or other features.

Unless defined otherwise, all the terms (including technical and scientific terms) used in this specification may be used as meanings that can be commonly understood by those skilled in the art. In addition, terms defined in commonly used dictionaries are not interpreted ideally or excessively unless clearly and specifically defined.

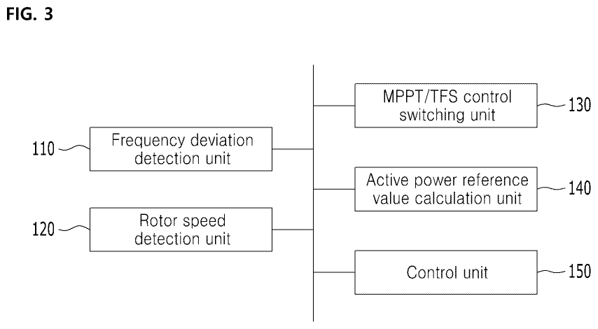

The present invention will be described in detail with reference to the drawings. FIG. 3 is a diagram for explaining a synthetic inertial control system of a wind turbine generator according to one embodiment of the present disclosure. A wind turbine generator controlled by a synthetic inertial control system of the present disclosure may include a full converter-based wind turbine generator (Type D), a doubly fed induction generator-based wind turbine generator (Type C), and the like, but the present disclosure is not limited thereto.

Referring to FIG. 3, a synthetic inertia control system of a wind turbine generator according to one embodiment of the present disclosure may include a frequency deviation detection unit 110, a rotor speed detection unit 120, an MPPT/TFS control switching unit 130, an active power reference value calculation unit 140, and a control unit 150.

The frequency deviation detection unit 110 detects a frequency deviation Δf, which is a difference between an actually measured frequency with respect to a reference frequency of the system. Although the present disclosure is described in terms of frequency deviation, a frequency change rate may be used instead of the frequency deviation, or the two pieces of information, frequency deviation and frequency change rate, may be combined and used. Therefore, even when someone replaces the frequency deviation of the present disclosure with a frequency change rate or a value obtained by combining the frequency deviation with the frequency change rate, the rate or value is merely an equivalent of the present disclosure.

The rotor speed detection unit 120 detects a rotor speed of the wind turbine generator.

The MPPT/TFS control switching unit 130 switches maximum power point tracking (MPPT) control to temporary frequency support (TFS) control when a frequency deviation detected by the frequency deviation detection unit is greater than a predetermined value.

Here, when the detected frequency deviation is greater than a predetermined value, it may be regarded as a case where a disturbance has occurred in the system, and when such a disturbance occurs, the kinetic energy of rotating bodies of synchronous generators in the system is released to cause a rotor speed of the synchronous generators to decrease, which results in a decrease in the system frequency.

In order to alleviate such a frequency dip, in the present disclosure, the MPPT control of the wind turbine generator is switched to TFS to perform an output control that is different from a normal operation, which will be described below.

The active power reference value calculation unit 140 calculates an active power reference value for TFS control based on a frequency deviation detected by the frequency deviation detection unit 110 and a rotor speed detected by the rotor speed detection unit 120.

The active power reference value calculation unit 140 may calculate, in response to a disturbance, an active power reference value in each step for controlling the wind turbine generator in the order of an active power increase step (first stage) through the release of kinetic energy of the rotor, a rotor speed convergence step (second stage), a step of moving a rotor speed onto a maximum power point tracking (MPPT) control curve (third stage), and a step of moving active power and a rotor speed along the MPPT control curve to an operating point prior to the occurrence of the disturbance.

The control unit 150 controls an active power output of the wind turbine generator according to a reference value of active power calculated by the reference value calculation unit 120. A control signal from the control unit 150 may include, for example, a form of a current command value, but the present disclosure is not limited thereto.

The terms such as frequency deviation detection unit 110, MPPT/TFS control switching unit 130, and active power reference value calculation unit 140 as shown in FIG. 3 may refer to a unit that processes at least one function or operation, which may be implemented in software and/or hardware.

The control unit 150 may be configured with a computing device including a memory that stores a program, and a processor that executes the program stored in the memory. The memory may include at least one type of storage medium among various types of storage media, which are publicly known in the related art. In addition, it may operate in conjunction with a web storage or cloud server that performs a storage function on the Internet.

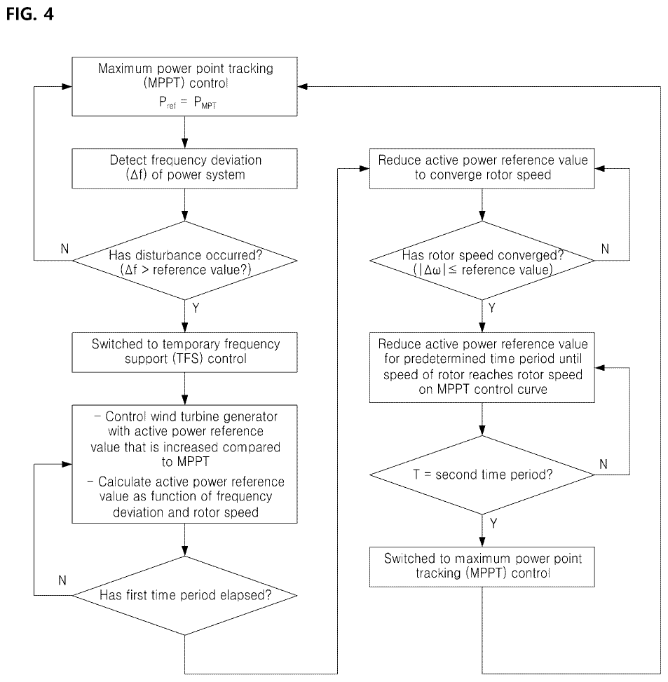

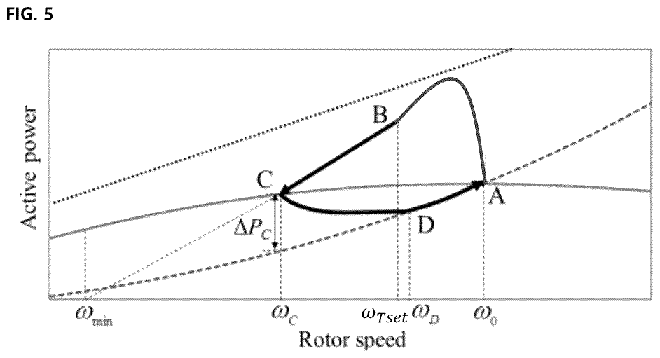

A synthetic inertia control system of a wind turbine generator according to the present disclosure may detect a disturbance that has occurred in a power system, and release kinetic energy of a rotor according to a magnitude of the disturbance to regulate an amount of increase in active power so as to obtain an effect of improving a lowest frequency, that is, reducing an amount of maximum dip in system frequency, as well as go through a speed convergence step of the rotor rather than simply relying on the operating characteristics of an automatic generation control (AGC) for the speed recovery of the rotor so as to allow rapid speed recovery. This will be described in more detail using FIGS. 4 and 5, and the like.

FIG. 4 is a flowchart for explaining a synthetic inertia control method of a wind turbine generator according to one embodiment of the present disclosure, and FIG. 5 is a graph showing a synthetic inertia control method of a wind turbine generator according to one embodiment of the present disclosure in an active power-rotor speed plane.

Referring to FIG. 4, a synthetic inertia control method of a wind turbine generator according to one embodiment of the present disclosure may include a step of switching to temporary frequency support (TFS) control when a disturbance is detected during a normal operation according to maximum power point tracking (MPPT) control, a step (first stage) of controlling the wind turbine generator with an active power reference value that is increased compared to the case of MPPT control for a first predetermined time period, a step (second stage) of continuously reducing the active power reference value after the first time period has elapsed to converge a rotor speed, and a step (third stage) of decreasing the active power reference value for a second time period after the rotor speed converges in the second stage to allow the converged rotor speed to reach a rotor speed on an MPPT control curve.

After the second time period has elapsed, the TFS control may be switched back to MPPT control to allow active power output and rotor speed prior to the disturbance can be recovered along the MPPT control curve.

FIG. 5 is a graph showing a reference value P_{ref} of active power controlled by a synthetic inertia control method of a wind turbine generator according to an embodiment of the present disclosure in an active power-rotor speed plane.

Referring to FIGS. 4 and 5 together, under normal conditions, the wind turbine generator is operating under maximum power point tracking (MPPT) control, and a frequency deviation and a wind turbine generator rotor speed in the system are periodically detected.

When it is determined that a disturbance has occurred in a power system due to a detected frequency deviation, maximum power point tracking (MPPT) control is switched to temporary frequency support (TFS) control, and after switching to the TFS control, the wind turbine generator is controlled according to a particular active power reference value according to the present disclosure.

Here, a disturbance may be, for example, a case where a system frequency dips beyond a deadband due to dropping out of a generator connected to a power system, and when such a disturbance is detected, a series of processes of the present disclosure for frequency settling may be performed. However, the present disclosure is not limited thereto, and it may of course be possible to detect a disturbance in a power system through means other than the system frequency.

In one or more embodiments, when a disturbance occurs in a power system to be switched to TFS control, the active power reference value calculation unit 140 calculates an active power reference value (P_{ref}) for controlling an output of a wind turbine generator by the following Equation 1, which is a function of a rotor speed ωᵣ and a frequency deviation Δf.

$${P}_{ref} ( {ω}_{r} , Δ f ) = {k}_{g} {ω}_{r}^{3} + a ( {ω}_{r} ) * Δ f , for {t}_{0} < t \leq {t}_{0} + {T}_{set} \qquad [ Equation 1 ]$$

Here, k_{g} is a constant for an MPPT operation, α(ωᵣ) is a control gain that varies with a rotor speed, and Tₛₑₜ is a first time period, which is a section A-B maintenance period.

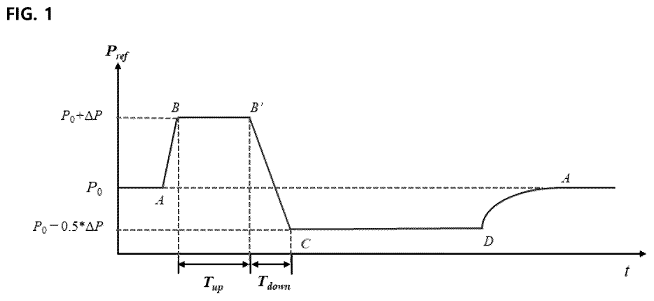

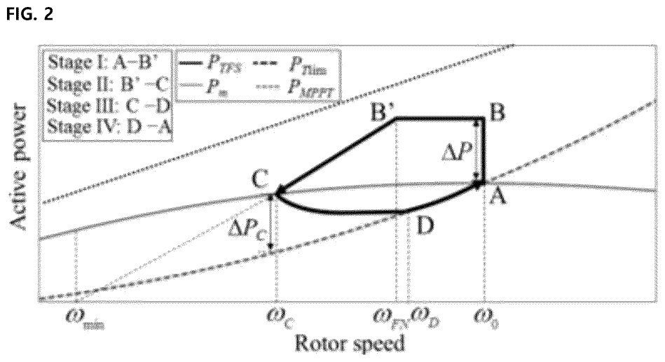

As shown in FIGS. 1 and 2, active power P_{ref} immediately after a disturbance in Non-Patent Documents 0001 and 0002 is calculated by adding a constant amount of increase in output AP to an active power value P₀ at the moment of the disturbance, that is, by setting P_{ref}(t)=P₀+ΔP. On the contrary, according to a synthetic inertia control method of the present disclosure, an active power reference value may be calculated to be proportional to a cube of a rotor speed ωᵣ, thereby more effectively preventing an OD phenomenon.

In other words, synthetic inertia of the wind turbine generator releases kinetic energy stored in a rotating body to rise a lowest frequency. However, since the kinetic energy stored in the rotating body is finite, when the kinetic energy is released excessively, it causes an OD phenomenon in which the rotor speed reaches a minimum rotor speed, and when a wind speed is low, an amount of increase in the output must be decreased in order to prevent the OD phenomenon, thereby having an insignificant effect of rising the lowest frequency, that is, reducing an amount of maximum dip in the system frequency.

However, as shown in Equation 1 of the present disclosure, when set to k_{g}ωᵣ³, the component decreases together with the decreasing rotor speed while performing the synthetic inertia function, and therefore, the effect of preventing OD becomes greater than when set to a constant as in Non-Patent Document 0001 and Non-Patent Document 0002.

In one or more other embodiments, k_{g}ωᵣ³ in Equation 1 may be set to a constant of a specific value, or may be set in the form of a function of k ωᵣ, k ωᵣ², k ωᵣ⁴, k ωᵣⁿ (here, k is an arbitrary constant) that is not a cubic function with respect to ωᵣ, or in the form of another function that varies depending on the rotor speed (ωᵣ).

Meanwhile, since the second term in Equation 1 is set to α(ωᵣ)*Δf, an output of the active power may increase in proportion to a magnitude of a disturbance (i.e., a deviation from a reference frequency due to a change in system frequency due to the disturbance). In cases where there is only a constant amount of increase in output (ΔP) regardless of a magnitude of a disturbance as shown in Non-Patent Document 0001 and Non-Patent Document 0002, when the magnitude of the disturbance is small, there is a possibility that excessive energy is released into the system to cause a frequency fluctuation. In addition, even when a magnitude of a disturbance is large, only a predetermined amount of energy may always be released, thereby limiting the effect of rising a lowest frequency.

On the contrary, according to an embodiment of the present disclosure, as the second term is set to be proportional to Δf, when the disturbance is small, an amount of increase in the output may also be proportionally small to prevent a frequency fluctuation phenomenon, and when the disturbance is large, the amount of increase in the output may be large so as to increase an effect of rising the lowest frequency to that extent.

As the control gain α(ωᵣ) that is proportional to a rotor speed of the present disclosure has the form of a function of a rotor speed or rather than a constant, a large output may be provided to the system at an initial stage of a disturbance, and then an output having a reduced magnitude than in the initial stage may be provided to the system since then. That is, a frequency deviation Δf multiplied by the control gain may be small in the initial stage of the disturbance, so it must be multiplied by a large control gain to provide a large output to the system. Therefore, the control gain α(ωᵣ) may be expressed as shown in the following Equation 2 to have a large control gain when the rotor speed is high and a small control gain when the rotor speed is low.

$$a ( {ω}_{r} ) = \sqrt{\frac{{G}_{max}^{2}}{{ω}_{max} - {ω}_{min}} ( {ω}_{r} - {ω}_{min} )} \qquad [ Equation 2 ]$$

Here, ωₘₐₓ represents a maximum rotor speed of a wind turbine generator, ωₘᵢₙ represents a minimum rotor speed thereof, and Gₘₐₓ represents a control gain of ωₘₐₓ. In one or more embodiments Gₘₐₓ may be set to 80, but is not limited thereto, and may of course be set to other values depending on system conditions.

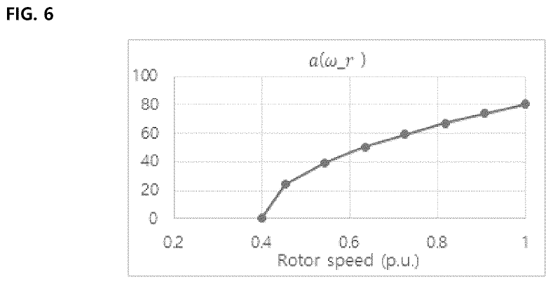

FIG. 6 is a graph showing a relationship between a control gain α(ωᵣ) with respect a rotor speed or in Equation 2.

Here, the maximum rotor speed ωₘₐₓ is 1.0, and the minimum rotor speed ωₘᵢₙ is set to 0.4. In a typical frequency-based synthetic inertia method, the control gain is set to about 20, but the control gain of the present disclosure has a value of above 20 in a section of ωᵣ>0.45, and is set to 80 at the maximum rotor speed ωₘₐₓ, thereby having a significant effect of rising a lowest frequency.

In addition, since the control gain is not constant while the wind turbine generator performs synthetic inertia and decreases together with the rotor speed, the control gain also decreases over time, thereby also having an OD prevention effect.

In one or more other embodiments, Equation 2 for the control gain α(ωᵣ) may be implemented in various forms that increase together with the increasing rotor speed rather than in the form of a root function.

The control unit 150 controls an output of the wind turbine generator for a predetermined first time period Tₛₑₜ based on the active power reference value calculated as shown above.

Here, the first time period Tₛₑₜ may be set to a time until the system frequency rebounds beyond the lowest frequency and converges to some extent. That is, it may be set to a time until a frequency deviation is reduced to be within a reference value (|Δf|≤reference value) or until an amount of change in frequency change rate is reduced to be within a reference value

$$( \vert \frac{df}{dt} \vert \leq reference value ) .$$

For example, the first time period Tₛₑₜ may be set to a time until the system frequency is detected to vary within a range of 0.1%.

In Non-Patent Document 0002, a time period for maintaining the active power P_{ref} to release as low kinetic energy as possible is set to a lowest frequency time period t_{FN}, that is, a time period it takes for the system frequency to reach a lowest point after the occurrence of a disturbance. The first time period Tₛₑₜ of the present disclosure is set to a time until the system frequency rebounds beyond the lowest frequency and converges to some extent, and thus set to be relatively larger than that of Non-Patent Document 0002. Nevertheless, in the present disclosure, an OD prevention effect may be maintained due to the control gain α(ωᵣ) as described above.

Referring back to FIG. 4, subsequent to a first stage control, when the first time period (Tₛₑₜ) has elapsed, a step (second stage) of converging the rotor speed through a control that continuously reduces the active power reference value is carried out. This corresponds to a section between B-C in FIG. 5, and the active power reference value P_{ref} may decrease along a straight line connecting between a point (ω_{Tset}, P_{ref} (Tₛₑₜ)) during the first time period Tₛₑₜ and a point (ωₘᵢₙ, 0) of the minimum rotor speed, and may be expressed as shown in the following Equation 3.

$${P}_{ref} ( {ω}_{r} ) = \frac{{P}_{ref} ( {T}_{set} )}{{ω}_{Tset} - {ω}_{min}} ( {ω}_{r} - {ω}_{min} ) \qquad [ Equation 3 ]$$

When the active power P_{ref} follows Equation 3, the rotor speed converges to point C, that is, (ω_{c}, P_{ref}(ω_{c})). Point C, which is a point where active power being output by the wind turbine generator and a mechanical input of the wind turbine generator become equal, corresponds to a point where a green curve representing the mechanical input of the wind turbine generator in FIG. 5 and a straight line represented by Equation 3 intersect.

Meanwhile, when the active power reference value of Equation 3 continuously decreases in a section B-C, it may be implemented in the form of a parabola or polynomial function rather than just a one-dimensional straight-line slope.

In addition, in FIG. 5, though it is described that an active power reference value that decreases along a straight line connecting point B and point (ωₘᵢₙ, 0) is used to converge the rotor speed to one point on a green curve (Pm curve), here, one point designated as the point (ωₘᵢₙ, 0) does not necessarily have to be the point (ωₘᵢₙ, 0), but only needs to be one of points under the Pm curve as well as in a region where ωᵣ<ω_{Tset}. Therefore, a function of the active power reference value may be set as a variety of functions connecting point B and one point under the Pm curve as well as in a region where ωᵣ<ω_{Tset}.

A rotor speed convergence condition for terminating the second stage may be set such that an amount of change in the rotor speed in a predetermined time interval (e.g., 260 psec, which is an output control time interval of the wind turbine generator) is within a predetermined value (e.g., |Δω|≤10⁻⁴).

When the rotor speed converges to point C through the control of the second stage, a control of recovering the reduced rotor speed is carried out this time. A step (third stage) of reducing the active power reference value for a second time period such that the rotor speed of the wind turbine generator reaches a rotor speed on the MPPT control curve corresponds to a section C-D in FIG. 5, and the active power reference value P_{ref} at this time may be calculated according to the following Equation 4.

$${P}_{ref} ( {ω}_{r} , t ) = {k}_{g} {ω}_{r}^{3} + Δ {P}_{C} [ - \frac{1}{Δ T} ( t - {t}_{C} ) + 1 ] , for {t}_{C} < t \leq {t}_{C} + Δ T \qquad [ Equation 4 ]$$

Here, k_{g} is a constant for an MPPT operation, ΔP_{c} is a difference between the active power at point C and k_{g}ω_{c}³, t_{c} is a time at point C, and ΔT is a second time period set to reach the MPPT control curve at point C.

Equation 4 represents P_{ref} for the rotor speed to reach the MPPT control curve subsequent to the time period ΔT.

In Non-Patent Document 0002, ΔT is set to 15 seconds for rapid rotor speed recovery, and in this case, although the rotor speed recovery is fast, a large frequency dip may occur in a section C-D, and in severe cases, the frequency may decrease below 59.8 Hz to cause AGC to stop its operation, thereby preventing the frequency from recovering to 60 Hz.

Therefore, in the present disclosure, in order to minimize a magnitude of a frequency dip that may occur in the third stage control, it is set to be ΔT≥45 s. In this case, the rotor speed recovery may be slower than in the case of Non-Patent Document 0002, but the AGC is prevented from stopping an operation due to a frequency dip that occurs during the rotor speed recovery process, and thus the frequency recovery to 60 Hz is not delayed.

The second term of Equation 4 has a form in which ΔP_{c} linearly decreases to 0 over time, but the present disclosure is not limited thereto, and ΔP_{c} may be implemented as various functions, including, for example, a polynomial function in which ΔT subsequently becomes 0.

When the second time period (ΔT) of the third stage control has elapsed to reach point D on the MPPT control curve, TFS control is switched back to maximum power point tracking (MPPT) control. Then, P_{ref} moves to point A along the MPPT control curve, and recovers to an operating point prior to the disturbance.

In FIG. 5 and a description related thereto, how to set an active power reference value for output control of a wind turbine generator in an active power-rotor speed plane has been described. However, since a torque may be obtained by dividing active power by a rotor speed, an active power reference value P_{ref} proposed in the present disclosure may also be implemented in a similar manner to the above-mentioned method in a torque-rotor speed plane.

Hereinafter, a verification test result in which a synthetic inertial control result according to an embodiment of the present disclosure is compared with conventional control methods will be described.

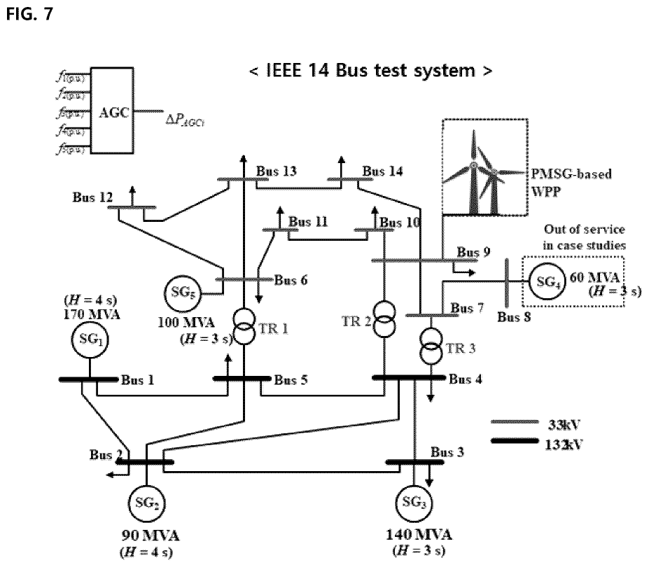

In order to verify the performance of the synthetic inertial control method and system according to the present disclosure, a test system as shown in FIG. 7 was used. FIG. 7 is a modified IEEE 14 bus system, in which an original IEEE 14 bus system included five synchronous generators, loads, and a transmission system (including a distribution system), and a total load is approximately 300 MW. SG4 with a rated capacity of 60 MVA, which had been connected to bus No. 8 in the IEEE 14 bus system, was separated from the system, and a PMSG wind power farm with a capacity of 66 MVA was connected to bus No. 9. For a disturbance, SG2 was separated from the system for 10 seconds, and the performance of the present disclosure was compared and verified by changing a wind speed and a magnitude of a disturbance.

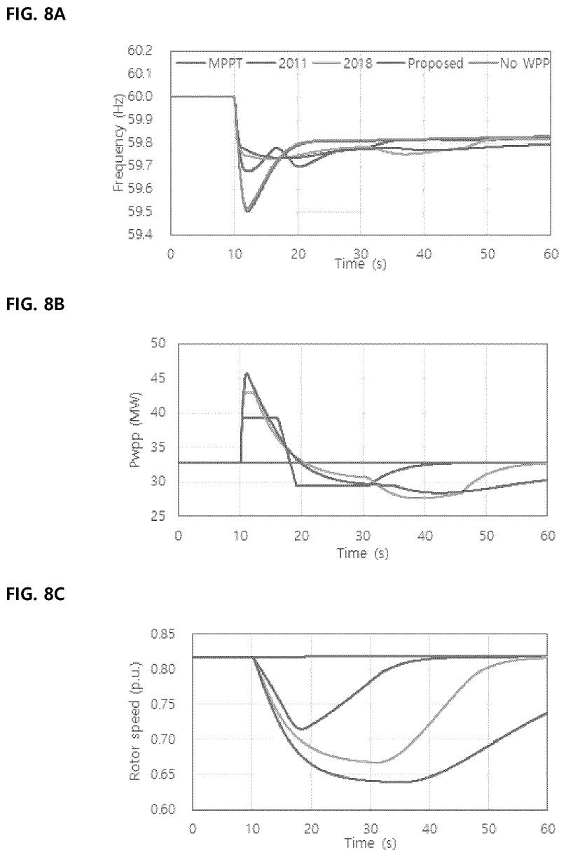

The results of the verification tests applied to the above test system will be described with reference to FIGS. 8 to 10.

### Verification Test Example 1

Verification Test Example 1 is a case where a wind speed is 9 m/s and a magnitude of a disturbance is 36 MW, wherein results for a system frequency (FIG. 8A), a wind farm output (FIG. 8B), and a rotor speed (FIG. 8C) are respectively shown in graphs during an MPPT operation, when a method of Non-Patent Document 0001 is applied (2011), when a method of Non-Patent Document 0002 is applied (2018), when an embodiment of the present disclosure is applied (Proposed), and when configured only with a synchronous generator (No WPP).

A lowest frequency during the MPPT operation was 59.499 Hz, which was 0.501 Hz lower than a rated frequency (reference frequency), and 0.015 Hz lower than when configured only with a synchronous generator. In the case of Non-Patent Document 0001, it was 59.676 Hz, and in the case of Non-Patent Document 0002, it was 59.728 Hz, but in the case of a configuration according to an embodiment of the present disclosure, it was 59.732 Hz, indicating the highest improvement in the lowest frequency.

Taking into account of an output of the wind farm immediately after a disturbance, the method of Non-Patent Document 0001 increases the output by 10%, maintains it for 6 seconds, and then decreases, while the method of Non-Patent Document 0002 increases it by 15.46%, maintains it for 3 seconds, and then decreases. When configured according to an embodiment of the present disclosure, it was observed that the output was increased in proportion to a frequency deviation immediately after a disturbance, and the output increased by above 10% than the method of Non-Patent Document 0002 was output for a longer period of 6 seconds. This leads to an improvement in the lowest frequency as described in FIG. 8A, and no frequency fluctuation phenomenon was observed.

In the case of a rotor speed, the method according to an embodiment of the present disclosure releases more kinetic energy than the method of Non-Patent Document 0002, which may lead to a rise in the lowest frequency. In addition, in the case of the present disclosure, although the speed recovery of the rotor is slower than that of Non-Patent Document 0002, it can be observed that an amount of dip and an amount of change in the system frequency during the rotor speed recovery process are more excellent.

### [Verification Test Example 2]

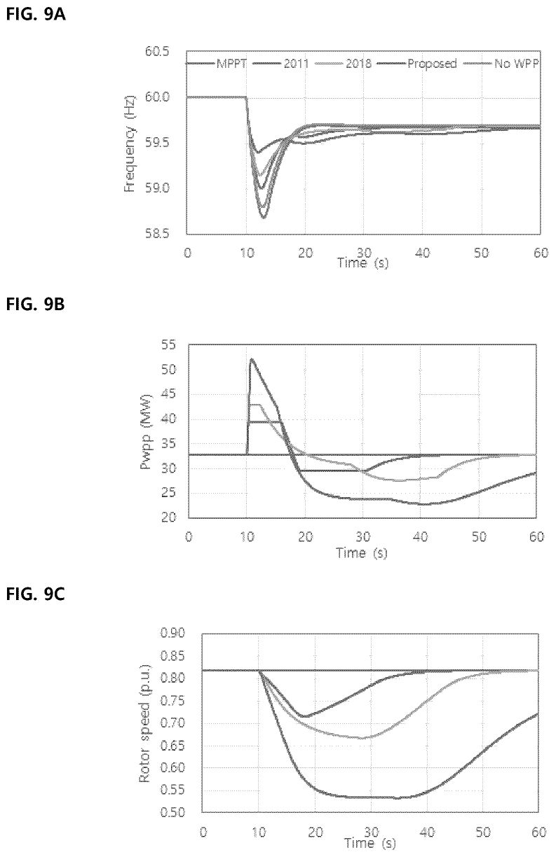

Verification Test Example 2 is a case where a wind speed is 9 m/s and a magnitude of a disturbance is 54 MW, wherein the magnitude of the disturbance approximately 1.4 times that of the first case, but the wind speed is the same. Results for a system frequency (FIG. 9A), a wind farm output (FIG. 9B), and a rotor speed (FIG. 9C) are respectively shown in graphs during an MPPT operation, when a method of Non-Patent Document 0001 is applied (2011), when a method of Non-Patent Document 0002 is applied (2018), when an embodiment of the present disclosure is applied (Proposed), and when configured only with a synchronous generator (No WPP).

A lowest frequency during the MPPT operation was 58.678 Hz, which was 1.313 Hz lower than a rated frequency (reference frequency), and 0.112 Hz lower than when configured only with a synchronous generator. In the case of Non-Patent Document 0001, it was 59.003 Hz, and in the case of Non-Patent Document 0002, it was 59.146 Hz, but in the case of a configuration according to an embodiment of the present disclosure, it was 59.396 Hz, and the improvement in the lowest frequency was 54.0%, which was 19% higher than the method of Non-Patent Document 0002.

Taking into account of an output of the wind farm immediately after a disturbance, the method of Non-Patent Document 0001 increases the output by 10%, maintains it for 6 seconds, and then decreases, while the method of Non-Patent Document 0002 increases it by 15.46%, maintains it for 3 seconds, and then decreases, thereby providing the same output even when the magnitude of the disturbance increases. On the contrary, when configured according to an embodiment of the present disclosure, the output was increased in proportion to a frequency deviation immediately after a disturbance, and the increased output is output for a longer period of 6 seconds than the method of Non-Patent Document 0002 In addition, in the moving of active power to an MPPT control curve, an amount of decrease in the output and an amount of dip in the frequency is smaller than in the method of Non-Patent Document 0002.

In the case of a rotor speed, it can be observed that the method according to an embodiment of the present disclosure releases more kinetic energy than the method of Non-Patent Document 0002, and releases more kinetic energy than in Verification Test Example 1. In addition, in the case of the present disclosure, although the speed recovery of the rotor is slower than that of Non-Patent Document 0002, it can be observed that an amount of dip and an amount of change in the system frequency during the rotor speed recovery process are more excellent.

### [Verification Test Example 3]

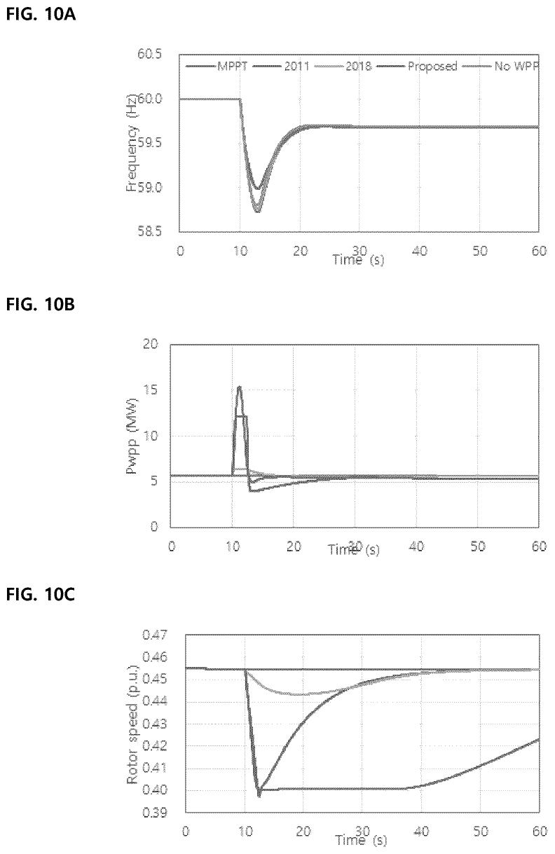

Verification Test Example 3 is a case where a wind speed is 5 m/s and a magnitude of a disturbance is 54 MW, wherein the magnitude of the disturbance is the same as in Verification Test Example 2, but the wind speed is low such that kinetic energy that can be released is very small. Results for a system frequency (FIG. 10A), a wind farm output (FIG. 10B), and a rotor speed (FIG. 10C) are respectively shown in graphs during an MPPT operation, when a method of Non-Patent Document 0001 is applied (2011), when a method of Non-Patent Document 0002 is applied (2018), when an embodiment of the present disclosure is applied (Proposed), and when configured only with a synchronous generator (No WPP).

The lowest frequency during an MPPT operation was 58.723 Hz, which was 0.076 Hz lower than when configured only with a synchronous generator.

Taking into account of an output of the wind farm immediately after a disturbance, the method of Non-Patent Document 0001 attempted to increase the output by 10% and maintain it for 6 seconds as shown in Verification Test Examples 1 and 2, but kinetic energy that can be released was small to reach the minimum rotor speed after 3 seconds and OD occurred (see FIG. 10C).

Therefore, the output decreased rapidly as the synthetic inertia was interrupted and returned to MPPT (see FIG. 10B). The lowest frequency was 58.982 Hz.

The method of Non-Patent Document 0002 also has a small amount of kinetic energy that can be released, and after increasing by 1.09%, which is much smaller than Verification Test Examples 1 and 2, it is maintained for 3 seconds and then decreases (see FIG. 7B). In this case, OD did not occur, but the lowest frequency was 58.758 Hz, which was 0.388 Hz lower than in Verification Test Example 2, so it was difficult to expect a significant rise in the lowest frequency.

On the contrary, when configured according to an embodiment of the present disclosure, the increased output is output for a longer period of 6 seconds than the method of Non-Patent Document 0002 in an active power increase step in proportional to a frequency deviation immediately after the disturbance. In addition, there were a section where an amount of increase in the output was greater than that of the method of Non-Patent Document 0001, but OD did not occur because the control gain was reduced as the rotor speed decreased. The lowest frequency is 58.972 Hz, which is improved by 0.214 Hz compared to a method of Non-Patent Document 0002.

Meanwhile, the steps of a control method according to the present disclosure may be implemented in the form of program commands that can be executed by a processor of a computing device and recorded on a computer-readable medium. An example of the computer-readable medium includes a hard disk, a ROM, a RAM, a CD-ROM, a hard disk, a magnetic tape, a floppy disk, an optical data storage device, and the like, but is not limited thereto.

Although the present invention has been described as described above, those skilled in the art will recognize that the present invention may be implemented in other forms while maintaining the technical ideas and essential features of the present invention.

Although the scope of right of the present invention will be determined basically by the patent claims, it should be interpreted that all changes or modified forms derived from equivalent configurations, as well as the configurations directly derived from the description of the patent claims, are included in the scope of right of the present invention.

### DESCRIPTION OF SYMBOLS

110: Frequency deviation detection unit
120: Rotor speed detection unit
130: MPPT/TFS control switching unit
140: Active power reference value calculation unit
150: Control unit

What is claimed is:

1. A synthetic inertia control method by a control system of a wind turbine generator, the method comprising:
performing maximum power point tracking (MPPT) control;
detecting a frequency deviation in a power system; and
switching, when the frequency deviation is greater than a predetermined value, the maximum power point tracking (MPPT) control to temporary frequency support (TFS) control;
wherein the temporary frequency support (TFS) control comprises:
a first stage of calculating and controlling, for a predetermined first time period from a time point (conversion time point) at which the maximum power point tracking (MPPT) control is converted to the temporary frequency support (TFS) control, an active power reference value that is increased from an original reference value according to the maximum power point tracking (MPPT) control at the conversion time point, and
wherein the increased active power reference value according to the temporary frequency support (TFS) control is calculated as a function of the frequency deviation and a rotor speed of the wind turbine generator.

2. The method of claim 1, further comprising:
a second stage of continuously reducing the active power reference value to converge a speed of the rotor;
a third stage of reducing the active power reference value for a second time period to allow the speed of the rotor to reach a rotor speed on the maximum power point tracking (MPPT) control curve; and
a stage of terminating the temporary frequency support (TFS) control and switching back to the MPPT control when the speed of the rotor reaches a rotor speed on the MPPT control curve,
wherein the active power reference value in the second stage is calculated as a function of the rotor speed, and
wherein the active power reference value in the third stage is calculated as a function of the rotor speed and a time.

3. The method of claim 1, wherein an equation for calculating the active power reference value of the first stage comprises:
a value obtained by multiplying the frequency deviation by a control gain that varies according to the speed of the rotor.

4. The method of claim 3, wherein the active power reference value of the first stage is calculated by the following equation:
$${P}_{ref} ( {ω}_{r} , Δ f ) = k * F ( {ω}_{r} ) + a ( {ω}_{r} ) * Δ f , for {t}_{0} < t \leq {t}_{0} + {T}_{set}$$
where the
$$k * F ( {ω}_{r} ) = {k}_{g} {ω}_{r}^{3}$$
(k_{g} is a constant for an MPPT operation), and
wherein k is an arbitrary constant, ωᵣ is a speed of a rotor, F(ωᵣ) is a function of w that varies with a rotor speed, α(ωᵣ) is a control gain that varies with the rotor speed, Δf is a deviation of a reference frequency and a measured system frequency, and Tₛₑₜ is the first time period.

5. The method of claim 4, wherein the F(ωᵣ)=ωᵣⁿ (n is 0 or a natural number).

6. The method of claim 4, wherein the control gain α(ωᵣ) that varies with the rotor speed is expressed by the following equation:
$$a ( {ω}_{r} ) = \sqrt{\frac{{G}_{max}^{2}}{{ω}_{max} - {ω}_{min}} ( {ω}_{r} - {ω}_{min} )}$$
where ωₘₐₓ is a maximum rotor speed of the wind turbine generator, ωₘᵢₙ is a minimum rotor speed, and Gₘₐₓ is a control gain of ωₘₐₓ.

7. The method of claim 2, wherein in the second stage, the reference value of the active power is reduced along a line connecting one of points under a Pm curve as well as within a region where ωᵣ<ω_{Tset} from a point in the first time period in an active power-rotor speed plane.

8. The method of claim 2, wherein the active power reference value of the second stage is calculated by the following equation:
$${P}_{ref} ( {ω}_{r} ) = \frac{{P}_{ref} ( {T}_{set} )}{{ω}_{Tset} - {ω}_{min}} ( {ω}_{r} - {ω}_{min} )$$
where P_{ref} (Tₛₑₜ) and ω_{Tset} are an active power reference value and a rotor speed, respectively, at a time point after the first time period has passed, ωᵣ is a speed of a rotor, and ωₘᵢₙ is a minimum rotor speed.

9. The method of claim 2, wherein the active power reference value of the third stage is calculated by the following equation:
$${P}_{ref} ( {ω}_{r} , t ) = {k}_{g} {ω}_{r}^{3} + Δ {P}_{C} [ - \frac{1}{Δ T} ( t - {t}_{C} ) + 1 ] , for {t}_{C} < t \leq {t}_{C} + Δ T$$
where ωᵣ is a speed of a rotor, k_{g} is a constant for an MPPT operation, ΔP_{c} is a difference between active power and k_{g}ω_{c}³ at a rotor speed point (point C in FIG. 5) converged in the second stage, t_{c} is a time point at point C, and ΔT is a second time period set to reach a rotor speed on the MPPT control curve at point C.

10. The method of claim 1, wherein the first time period is a time period during which the system frequency deviation falls within a predetermined reference value after the system frequency has rebounded beyond the lowest frequency.

11. A synthetic inertial control system of a wind turbine generator, the system comprising:
a frequency deviation detection unit that detects a frequency deviation of a power system from a reference frequency and a measured system frequency;
a rotor speed detection unit that detects a rotor speed of a wind turbine generator;
a switching unit that switches between maximum power point tracking (MPPT) control and temporary frequency support (TFS) control;
an active power reference value calculation unit that calculates an active power reference value for wind turbine generator output control using the frequency deviation and the rotor speed; and
a control unit that controls a wind turbine generator according to the calculated active power reference value,
wherein when switched to the temporary frequency support (TFS) control by the switching unit,
the active power reference value calculation unit calculates an active power reference value that is increased from an original reference value according to the maximum power point tracking (MPPT) control at a time point (conversion time point) converted to the temporary frequency support (TFS) control,
the increased active power reference value is calculated as a function of the frequency deviation and the rotor speed, and
the control unit performs a first stage control according to an active power reference value calculated as a function of the frequency deviation and the rotor speed for a predetermined first time period from the conversion time point.

12. The system of claim 11, wherein the active power reference value calculation unit calculates an active power reference value of the second stage that continuously decreases as a function of the rotor speed, and an active power reference value of the third stage as a function of the rotor speed and a time,
wherein the control unit performs a second stage control that continuously reduces active power according to the active power reference value of the second stage to converge a speed of the rotor, and a third stage control for a second time period to allow the speed of the rotor to reach a rotor speed on the MPPT control curve according to the active power reference value of the third stage, and
wherein the switching unit terminates the temporary frequency support (TFS) control and switches back to the MPPT control when the speed of the rotor reaches a rotor speed on the MPPT control curve.

13. The system of claim 11, wherein an equation for calculating the active power reference value of the first stage comprises:
a value obtained by multiplying the frequency deviation by a control gain that varies according to a speed of the rotor.

14. The system of claim 13, wherein the active power reference value for the first stage control is calculated by the following equation:
$${P}_{ref} ( {ω}_{r} , Δ f ) = k * F ( {ω}_{r} ) + a ( {ω}_{r} ) * Δ f , for {t}_{0} < t \leq {t}_{0} + {T}_{set}$$
where
$$k * F ( {ω}_{r} ) = {k}_{g} {ω}_{r}^{3}$$
(k_{g} is a constant for an MPPT operation), and
wherein k is an arbitrary constant, ωᵣ is a speed of a rotor, F(ωᵣ) is a function of ωᵣ that varies with a rotor speed, α(ωᵣ) is a control gain that varies with the rotor speed, Δf is a deviation of a reference frequency and a measured system frequency, and Tₛₑₜ is a first time period.

15. The system of claim 14, wherein F(ωᵣ)=ωᵣⁿ (n is 0 or a natural number).

16. The system of claim 14, wherein the control gain α(ωᵣ) that varies with the rotor speed is expressed by the following equation:
$$a ( {ω}_{r} ) = \sqrt{\frac{{G}_{max}^{2}}{{ω}_{max} - {ω}_{min}} ( {ω}_{r} - {ω}_{min} )}$$
where ωₘₐₓ is a maximum rotor speed of the wind turbine generator, ωₘᵢₙ is a minimum rotor speed, and Gₘₐₓ is a control gain of ωₘₐₓ.

17. The system of claim 12, wherein the second stage control is a control that reduces a reference value of the active power along a line connecting one of points under a Pm curve as well as within a region where ωᵣ<ω_{Tset} from a point in the first time period in an active power-rotor speed plane.

18. The system of claim 12, wherein the active power reference value for the second stage control is calculated by the following equation:
$${P}_{ref} ( {ω}_{r} ) = \frac{{P}_{ref} ( {T}_{set} )}{{ω}_{Tset} - {ω}_{min}} ( {ω}_{r} - {ω}_{min} )$$
where P_{ref} (Tₛₑₜ) and ω_{Tset} are an active power reference value and a rotor speed, respectively, at a time point after the first time period has passed, ωᵣ is a speed of a rotor, and ωₘᵢₙ is a minimum rotor speed.

19. The system of claim 12, wherein the active power reference value for the third stage control is calculated by the following equation:
$${P}_{ref} ( {ω}_{r} , t ) = {k}_{g} {ω}_{r}^{3} + Δ {P}_{C} [ - \frac{1}{Δ T} ( t - {t}_{C} ) + 1 ] , for {t}_{C} < t \leq {t}_{C} + Δ T$$
where ωᵣ is a speed of a rotor, k_{g} is a constant for an MPPT operation, ΔP_{c} is a difference between active power and k_{g}ω_{c}³ at a rotor speed point (point C in FIG. 5) converged in the second stage, t_{c} is a time point at point C, and ΔT is a second time period set to reach a rotor speed on the MPPT control curve at point C.

20. The system of claim 11, wherein the first time period is a time period during which the system frequency deviation falls within a predetermined reference value after the system frequency has rebounded beyond the lowest frequency.
